(19) United States
(12) Patent Application Publication
(10) Pub. No.: US 2025/0146608 A1
(43) Pub. Date: May 8, 2025

(54) DEVICES AND METHODS OF MANUFACTURING COUPLERS FOR THE TRANSITION OF DIFFERENT CONDUIT SYSTEMS

(71) Applicant: ABB Schweiz AG, Baden (CN)

(72) Inventors: Neil Allen Brown, Jonesboro, AR (US); Omar Lopez, Memphis, TN (US)

(21) Appl. No.: 18/386,708

(22) Filed: Nov. 3, 2023

(51) Int. Cl. F16L 47/12; B29C 65/00; B29K 627/06; B29L 31/24; F16L 47/02; F16L 47/16

(52) U.S. Cl. CPC F16L 47/12; B29C 66/5221; F16L 47/02; F16L 47/16; B29K 2627/06; B29L 2031/24

(57) ABSTRACT

Devices for coupling to a first and second conduit and methods of manufacturing the same. The device may include a first member defining a channel having a first opening and second opening, and one or more threads located on an inner surface of the channel at the second opening, the first member configured to receive the first conduit at the first opening and the second conduit at the second opening, and the one or more threads engages one or more threads of the second conduit. The device may include a second member circumferentially disposed around a periphery of the first member and axially extending therefrom, the second member including an inner diameter configured based on an outer diameter of the second conduit to enable the second member to form a seal around the second conduit when the second conduit fully engages the first member.

### FIELD

The present disclosure relates to the field of electrical conduits. More particularly, to coupling devices for transitioning between different conduit systems.

### BACKGROUND

Conduit pipes are used to allow electrical wires to extend through an enclosed channel formed by the pipe so that the electrical wires can traverse between locations. Conduit pipes can be connected together using a conduit coupling device which typically couples to one conduit at one end and another conduit at another end. Typically, conduit couplers are made of similar materials as the conduit pipes being coupled together. Oftentimes, based on installation requirements and specific applications in a facility where the electrical conduit pipes are installed, one or more types of conduits may be utilized. For example, one system may utilize non-metallic PVC conduits and another system may utilize PVC coated metallic conduits and the two systems need to be coupled together to enable electrical wiring to traverse therethrough between systems.

### SUMMARY

Conventional coupling devices for transitioning between conduit pipes is oftentimes formed of a similar material as the conduits being joined together. When joining conduit pipes of different types, e.g., formed with one or more different materials, the coupler of one conduit type is typically utilized to connect the two types of conduits together. However, these conventional coupling devices may need to be modified based on the desired configuration such that both types of conduit pipes can be installed onto and connected to the coupler that is originally configured for coupling one type of conduit together. For example, a non-metallic Polyvinyl Chloride (“PVC”) male adapter may be threaded into a PVC coated coupling sleeve so that a non-metallic PVC conduit may be transitioned to a PVC coated metallic conduit. Another conventional approach for coupling different conduit types is to use a non-ribbed PVC female adapter and connecting it to a threaded male end of the PVC coated metallic conduit.

To ensure there are no voids at the connection point, a PVC patch compound may need to be applied to the connection point between the PVC coated coupling sleeve and the non-metallic PVC male adapter. For example, the connection point between the non-ribbed PVC female adapter and the threaded PVC coated metallic conduit may leave threads exposed even when fully installed, which may then be susceptible to corrosion buildup and may eventually lead to pinhole formation. This is a result of the protective coating on the exposed metallic threads being stripped off when the threads are formed on the PVC coated metallic conduit. As a result, the connection point and the exposed threads may need to be covered using a patch compound such that the patch compound overlaps the PVC coating of the conduit and the PVC female adapter and any exposed threads therebetween to ensure a sealed connection and to prevent corrosion buildup at the exposed threads.

However, the applied patch compound needs to be applied to form a certain minimum thickness (e.g., the thickness of the original factory PVC coating) and thereby may require multiple applications, with each layer being cured (e.g., with a heat gun) prior to applying the next layer. This is to ensure that the entire patched area is free of gaps and pinholes. Additionally, if the exposed threads are greater than a certain width, vinyl or PVC tape may also need to be used to wrap the gap (exposed threads) to the desired thickness and then the entire area covered with a sealant or PVC patch compound to ensure no gaps or pinholes exist therein.

However, these conventional coupling devices as known in the prior art typically require additional components and/or materials to form sealed connection points and/or to protect against corrosion buildup. The coupling devices may need PVC patch compound or PVC tape applied at the connection points to ensure that there are no voids or pinholes. Moreover, as the patch compound may need to meet minimum thickness requirements based on the facility wherein the coupling device is being installed, such applications can be time consuming and can lead to gaps or pinholes if improperly applied. Therefore, forming these conventional coupling devices can be labor intensive and relies heavily on the skill and consistency of the installer, which can lead to inconsistencies in the resulting coupling device with varying degrees of success with regards to performance when installed.

Various embodiments of the present disclosure relate to systems, devices, and apparatus for a conduit coupler configured to couple a first conduit to a second conduit, the conduit coupler being capable of coupling to one or more different types of conduits at each respective end. In some embodiments, the conduit coupler may couple together two conduits of the same type. In other embodiments, the conduit coupler may couple together a first type of conduit and a second type of conduit. For example, in some embodiments, the first conduit may be a non-metallic PVC conduit and the second conduit may be a PVC coated metallic conduit. The conduit coupler as described in the present disclosure provides an integrally formed coupling device for connecting to the first conduit and the second conduit, thereby eliminating the need to modify the coupler to connect different conduit types and also eliminating the need for a user to install individual components together to form a coupling device for connecting to the first conduit and the second conduit. Furthermore, the conduits may be installed into the conduit coupler using industry standard methods and tools.

Various embodiments of the present disclosure provide one integrally formed component providing two distinct conduit connections at each end that allows for a corresponding conduit type to be installed at the respective end using industry standard methods and tools. In this regard, the need to modify the coupling device and/or need to install additional components to form the coupling device is eliminated. In some embodiments, the coupling device includes a rigid member over molded with a sealing sleeve, with one end of the rigid member having an appropriate conduit connection to allow a non-metallic PVC conduit to be installed therein and an opposite end of the rigid member having one or more threads for receiving one or more threads of a male end of a PVC coated metallic conduit to be installed therein. The sealing sleeve being configured to seal around a periphery of the PVC coated metallic conduit once fully installed into the one or more threads of the rigid member so that no gaps or pinholes that may be at the connection point is exposed to the exterior environment.

In various embodiments, the inner diameter of the rigid member may vary based on the outer diameter of the different conduits being coupled together. In some embodiments, the conduits being coupled together may have a substantially similar outer diameter. In other embodiments, the outer diameter of the different conduits may be different from the other and the rigid member may include dimensions configured to accommodate each respective conduit type and provides a transition therebetween formed by the channel. Moreover, the sealing sleeve is configured to conform to the dimensions of the conduit being installed into the one or more threads of the rigid member such as to provide a seal at the connection point and to cover any exposed threads. In this regard, in some embodiments, the inner diameter of the sealing sleeve may be based on the properties of the sealing sleeve. In some embodiments, the inner diameter of the sealing sleeve may also be based on the outer diameter of the conduit being inserted into the sealing sleeve and the rigid member.

In this regard, the sealing sleeve may be formed of a flexible polymer that is over molded onto the rigid member. In some embodiments, the flexible polymer, when fully cured during the manufacturing process, may provide the sealing sleeve with certain elastic properties to enable the sealing sleeve to conform to an outer dimension of the PVC coated metallic conduit when installed therein, while also forming a seal at the connection point between the rigid member and the conduit without having to perform any other processing or manufacturing steps to the sealing sleeve such as, for example, applying heat to the sealing sleeve using a heat gun or some other like techniques. In some embodiments, the flexible polymer, when fully cured during the manufacturing process, may also provide the sealing sleeve may certain rigidity such that the sealing sleeve retains its position relative the rigid member such as, for example, through engagement of certain retention features located on the exterior surface of the rigid member or using an adhesive applied to the contacting surfaces of the rigid member and the sealing sleeve. In addition, in some embodiments, the rigidity of the sealing sleeve may be such that for a certain sealing sleeve having a certain inner diameter, only conduits having an outer diameter within a fixed threshold limit greater than the inner diameter of the sealing sleeve may be inserted therein. In some embodiments, the sealing sleeve may provide increased friction forces which may render it difficult to install conduits having an outer diameter greater than this fixed threshold limit. In other embodiments, the sealing sleeve may experience deformation or shearing stresses as a result of conduits having an outer diameter greater than the fixed threshold limit, which may then compromise the sealing ability of the sealing sleeve.

The rigid member may be formed from a material having a first melting temperature and the sealing sleeve may be formed from a material having a second melting temperature. In some embodiments, the rigid member may be formed from a non-metallic PVC material having a first melting temperature and the sealing sleeve may be formed from a flexible polymer having a second melting temperature. As the sealing sleeve is formed onto the rigid member using an over molding process, the second melting temperature may be less than or substantially equal to the first melting temperature, according to some embodiments. This enables the sealing sleeve to be over molded onto the rigid member without causing material degradation (e.g., melting) of the rigid member as the coupling device cannot be properly formed if the flexible polymer has a melting temperature greater than the melting temperature of the material of the rigid member.

In addition, the sealing sleeve is formed such that a portion of the sealing sleeve extends beyond the rigid member, such that the channel defined by the rigid member also extends through the sealing sleeve, thereby placing a first end of the coupling device in fluid communication with a second end of the sealing sleeve. As such, when the two conduits are coupled to each respective end, the conduit segments (and their respective conduit systems) are also placed in fluid communication with each other to enable the electrical wiring to extend between the two systems. The length of the portion of the sealing sleeve that extends beyond the rigid member may vary. In some embodiments, the length by which the portion of the sealing sleeve extends beyond the rigid member may be based on a specific standard of the facility where the coupling device is being installed.

In some embodiments, the coupling device may include a first member for coupling together two conduit types, wherein the improvement comprises a sealing sleeve circumferentially disposed around the first member adjacent an end of the first member configured to receive a PVC coated metallic conduit, a portion of the sealing sleeve extending from an end of the first member such that a conduit inserted into a channel of the first member axially extends through the sealing sleeve to engage the first member. In some embodiments, an inner diameter of the sealing sleeve is configured based on the outer diameter of the conduit to enable the portion of the sealing sleeve to form a seal around the conduit at the connection point of the first member and the conduit. In some embodiments, a method of manufacturing the coupling device including a first member, wherein the improvement comprises obtaining the first member having a first melting temperature, obtaining a flexible polymer material having a second melting temperature, and over molding the flexible polymer material onto the first member at a temperature less than the first melting temperature and above the second melting temperature to form a second member, a portion of the second member axially extending from the first member further defines the channel such that a first end of the coupling device is in fluid communication with a second end of the coupling device.

It is to be appreciated by those having ordinary skill in the art that the specific dimensions of the coupling device, unless specified otherwise, is not intended to be limiting and the coupling device may include any of a plurality of dimensions suitable to enable the coupling device to transition between two different conduit types in accordance with the present disclosure.

In some embodiments, a device for coupling a first conduit and a second conduit includes a first member including a body defining a channel having a first opening and a second opening, and one or more threads located on an inner surface of the channel at the second opening, the first member configured to receive the first conduit at the first opening and receive the second conduit at the second opening, and the one or more threads engages one or more threads of the second conduit, and a second member circumferentially disposed around a periphery of the first member at the second opening and axially extending from the first member, the second member includes an inner diameter configured based on an outer diameter of the second conduit to enable a portion of the second member extending from the first member to form a seal around the second conduit when the second conduit fully engages the first member.

In some embodiments, the first member includes a non-metallic Polyvinyl Chloride (PVC) material.

In some embodiments, the second member includes a flexible polymer.

In some embodiments, the second member includes a rigidity provided by the flexible polymer to enable forming the seal between the second conduit and the first member, the second member further includes an elasticity provided by the flexible polymer to enable the second member to conform to an outer diameter of the second conduit.

In some embodiments, the device is formed by over molding the second member onto the periphery of the first member, a melting temperature of the first member is substantially similar to a melting temperature of the second member.

In some embodiments, further including an adhesive, and the adhesive attaches the first member to the second member, the adhesive is made of a material selected based on a material of the first member and the second member to enable the adhesive to attach the first member to the second member.

In some embodiments, the first conduit includes a non-metallic PVC conduit, the second conduit includes a PVC coated metallic conduit.

In some embodiments, a portion of the second member extending from the first member further defines the channel, the channel extends through the first member and the second member such that a first end of the device is in fluid communication with a second end of the device.

In some embodiments, the first member is further configured to engage the first conduit such that a seal is formed when the first conduit is fully inserted into the channel at the first opening.

In some embodiments, further including an adhesive, the adhesive is configured to be applied to respective surfaces of the first conduit and the first member to enable the seal to be formed between the first conduit and the first member.

In some embodiments, a system for coupling a first conduit and a second conduit including a coupling device for coupling the first conduit and the second conduit including a first member including a body defining a channel having a first opening and a second opening, and one or more threads located on an inner surface of the channel at the second opening, the first member is configured to receive the first conduit at the first opening and receive the second conduit at the second opening, and the one or more threads engages one or more threads of the second conduit, and a second member circumferentially disposed around a periphery of the first member at the second opening and axially extending from the first member, the second member includes an inner diameter configured based on an outer diameter of the second conduit to enable a portion of the second member extending from the first member to form a seal around the second conduit when the second conduit fully engages the first member, the channel extends through the first member and the second member such that a first end of the coupling device is in fluid communication with a second end of the coupling device, the coupling device is formed by over molding the second member onto the periphery of the first member.

In some embodiments, the first member includes a non-metallic Polyvinyl Chloride (PVC) material, the second member includes a flexible polymer.

In some embodiments, the first conduit includes a non-metallic PVC conduit, the second conduit includes a PVC coated metallic conduit.

In some embodiments, the second member includes a rigidity provided by the flexible polymer to enable forming the seal between the second conduit and the first member, the second member further includes an elasticity provided by the flexible polymer to enable the second member to conform to an outer diameter of the second conduit.

In some embodiments, a melting temperature of the first member is substantially similar to a melting temperature of the second member.

In some embodiments, the system further includes an adhesive, and the adhesive attaches the first member to the second member, the adhesive is made of a material selected based on a material of the first member and the second member to enable the adhesive to attach the first member to the second member.

In some embodiments, the first member is further configured to engage the first conduit such that a sealed connection is formed when the first conduit is fully inserted into the channel at the first end.

In some embodiments, the system further includes an adhesive, the adhesive is configured to be applied to surfaces of the first conduit and the first member to enable the sealed connection to be formed between the first conduit and the first member.

In some embodiments, a method of manufacturing a coupling device includes obtaining a first member having a first melting temperature, the first member includes a body defining a channel having a first opening and a second opening, and one or more threads located on an inner surface of the channel at the second opening, obtaining a flexible polymer material having a second melting temperature, and over molding the flexible polymer material onto the first member at a temperature less than the first melting temperature and above the second melting temperature to form a second member, a portion of the second member axially extending from the first member further defines the channel such that a first end of the coupling device is in fluid communication with a second end of the coupling device.

In some embodiments, the method further includes applying an adhesive onto an outer surface of the first member to enable the second member to attach to the first member, the adhesive is selected from a group of materials based on a material of the first member and the second member to enable the adhesive to attach the first member to the second member.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view illustrating a device, according to some embodiments.

FIG. 2 is an exposed side view illustrating the device, according to some embodiments.

FIG. 3 is a perspective view of a device, according to some embodiments.

FIG. 4 is an exposed side view of the device, according to some embodiments.

FIG. 5 is a perspective view illustrating a system including the device of FIG. 1, according to some embodiments.

FIG. 6 is an exposed side view of the system including the device of FIG. 1, according to some embodiments.

FIG. 7 is a flow diagram illustrating a method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

FIG. 1 is a perspective view illustrating a device 100, according to some embodiments.

Device 100 has a first end 102 and a second end 104 opposite the device 100 from the first end 102, and the device 100 includes member 106 (e.g., rigid member) adjacent the first end 102 and member 108 (e.g., sealing sleeve) adjacent the second end 104. In various embodiments, the member 106 may be referred to as a first member 106 and member 108 may be referred to as a second member 108. The device 100 is configured to couple two conduit pipe segments together, as will be further described herein. In some embodiments, the device 100 is configured to receive a first type of conduit at the first end 102 and receive a second type of conduit at the second end 104, the first member 106 including structural features capable of engaging and fixedly retaining the first and second type of conduit installed therein at the respective ends and the second member 108 being configured to seal a connection point between the first member 106 and the conduit being installed into the first member 106 adjacent the second member 108 (and through the second member 108).

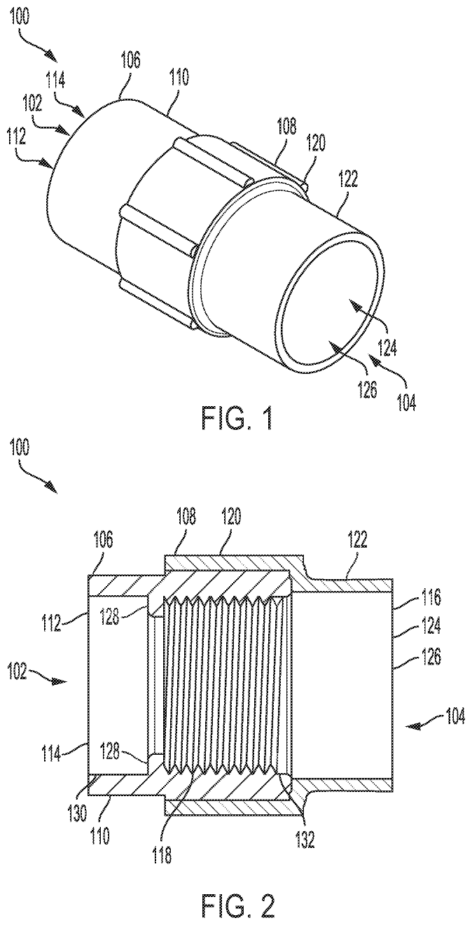

The first member 106 includes a body 110 defining a channel 112 axially extending through the first member 106 such that an end of first member 106 is in fluid communication with an opposite end of the first member 106. The body 110 and channel 112 further define an opening 114 and an opening 116 (FIG. 2) at opposite ends of the first member 106. In some embodiments, the first member 106 may also include one or more threads 118 (FIG. 2) disposed on at least a portion of an inner surface of the channel 112, as will be further described herein.

The first member 106 may be a rigid member and the first member 106 may be configured to receive conduit pipes at opposite ends (e.g., at opening 114 and opening 116) to couple the two segments of conduit pipes together. In various embodiments, the first member 106 may be configured to engage the conduits while substantially resisting mechanical deformation in response to force being applied during the coupling of the conduit pipes to the first member 106. In some embodiments, the first member 106 may resist mechanical deformation so long as the force applied to the first member 106 such as through one of the conduit pipes being installed into the respective end of first member 106, is below a certain threshold.

The first member 106 may be formed of one or more materials, according to various embodiments. In some embodiments, the first member 106 may be formed of a non-metallic Polyvinyl Chloride (“PVC”) material. In other embodiments, the first member 106 may be substantially formed of a non-metallic PVC material and one or more other non-metallic materials. For example, the first member 106 may be formed of PVC and one or more other filler materials to provide, for example, improved durability, rigidity, resistance to degradation, or the like, or any combinations thereof. In certain other embodiments, the first member 106 may be a PVC coated metallic coupler. In addition, the first member 106 may be formed by any of a plurality of manufacturing processes including, but not limited to, using molds, extrusion, injection molding, sintering, other processes, or any combinations thereof, and which may be known to persons having ordinary skill in the art for forming a rigid coupling member. In some embodiments, the manufacturing processes for forming the first member 106 may be substantially similar to processes for manufacturing at least one of the conduits being coupled to the device 100. It is to be appreciated by persons having ordinary skill in the art that the processes and materials for forming the device 100 is not intended to be limiting and may include any of a plurality of processes and/or materials to enable forming the device 100 in accordance with the present disclosure.

It is to be appreciated by those having ordinary skill in the art that the first member 106 illustrated in FIG. 1 and the other figures is exemplary and not intended to be limiting. In this regard, it is to be appreciated by those having ordinary skill in the art that the first member 106 may include one or more of the features as described in the present disclosure, or may include one or more other features that are not described herein, such as to enable the first member 106 to couple to a conduit at the first end 102 and to enable the first member 106 to also couple to a second conduit at the opposite end of the first member 106 from the first end 102. For example, in some embodiments, the first member 106 may further include at least one retention feature (e.g., embossment, protrusion, detent, etc.) located on the outer surface and the second member 108 may engage the retention feature to retain the second member 108 on the first member 106.

The second member 108 includes a body 120 that defines a sealing sleeve 122 circumferentially disposed around a periphery of the first member 106 at the opening 116. In some embodiments, and as shown in FIG. 1, the sealing sleeve 122 may be circumferentially disposed around a portion of an outer surface of the first member 106 from opening 116 (FIG. 2) and towards the first end 102 and towards opening 114. In other embodiments, the second member 108 may be formed onto the first member 106 such that the second member 108 substantially covers the outer surface of the first member 106, as will be further described herein.

In various embodiments, the second member 108 may extend from the first member 106 towards the second end 104 by a certain length. The second member 108 extends from the end of the first member 106 having opening 116 and extends in an axial direction towards the second end 104. In some embodiments, the second member 108 may substantially be in colinear alignment with channel 112 as the second member 108 extends towards the second end 104. According to various embodiments, the second member 108 extends from the first member 106 such that the second member 108 forms a sealing sleeve 122 that seals the connection point of the first member 106 and the conduit extending through the second member 108 and installed into the opening 116. In some embodiments, the length to which the second member 108 extends from the first member 106 may be based on the type and/or diameter of the conduit being installed into the first member 106, such as to enable the sealing sleeve 122 to fully cover the connection point and form a seal therebetween. In other embodiments, the conduit inserted through the second member 108 and installed into the first member 106 may be a threaded male end of the conduit, and the conduit may leave threads exposed beyond the perimeter of the body 110 of the first member 106 when the conduit is fully installed into the first member 106. In this regard, the sealing sleeve 122 of the second member 108 extending from the first member 106 may include a length sufficient to fully cover the exposed threads on the conduit extending therethrough to provide a fully enclosed and sealed connection point. In various embodiments, the length to which the second member 108 extends from the end of the first member 106 towards the second end 104 can vary based on the specific standards as established based on the application and/or by the facility where the device 100 is being installed.

The second member 108 may further define a channel 124, according to various embodiments. In some embodiments, a portion of the channel 124 may extend around a periphery of the first member 106 and another portion of channel 124 may extend from the end of first member 106 and towards the second end 104. In some embodiments, the channel 124 may form an opening 126 at the second end 104 and the channel 124 may extend, at least in part, from the second end 104 to the opening 116 of the first member 106 leading to channel 112. In this regard, the channel 124 of the second member 108 may extend between the second end 104 and onto a periphery of the first member 106, thereby placing the channel 124 and channel 112 in fluid communication with each other, and also placing the first end 102 of device 100 in fluid communication with the second end 104 of device 100, according to some embodiments. The first end 102 being in fluid communication with the second end 104 of device 100 enables the device 100 to place a conduit installed into the device 100 at first end 102 to be in fluid communication with another conduit installed into the device 100 at the second end 104, according to some embodiments. In addition, the conduit installed into the device 100 at the first end 102, when fully installed, is configured to be installed into channel 112 of the first member 106 at opening 114 and the conduit installed into the device 100 at the second end 104, when fully installed, is configured to also be installed into channel 112 at opening 116, according to various embodiments. As such, in some embodiments, the channel 112 of first member 106 connects with the two conduits at respective openings 114, 116 and places the two conduits in fluid communication with each other, with the second member 108 acting as a sealing sleeve to seal the connection point between the first member 106 and the conduit when the conduit is fully installed into the first member 106.

The second member 108 may be made of a polymer material that is formed onto a periphery of the first member 106, according to various embodiments. In some embodiments, the second member 108 may be made of a flexible polymer material that when fully cured may have elastic properties capable of sealing the connection point between the first member 106 and the conduit when the conduit is fully installed into the first member 106 and extending through the channel 124 of second member 108. The flexible polymer material forming the second member 108 may also have a sufficient rigidity when fully cured to enable the second member 108 to be formed onto the periphery of the first member 106 such that the second member 108 retains its position relative to the first member 106. In other embodiments, the second member 108 may be made of a flexible polymer material having sufficient rigidity such that the second member 108 is capable of receiving a conduit having an outer diameter less than (or equal to) a certain threshold diameter so that the conduit can extend through the second member 108 and connect to the first member 106 without the second member 108 experiencing deformation which materially affects the elastic properties of the second member 108, thereby preventing the second member 108 from forming a seal at the connection point between the first member 106 and the conduit inserted therethrough.

In some embodiments, the rigid and elastic properties of the second member 108, e.g., the maximum outer diameter of conduit that may extend therethrough, may be based on any of a plurality of factors including, but not limited to, the materials of second member 108, the standards for forming the sealed connection point determined based on the specific application (i.e., prescribed technical specifications) and/or the requirements of the facility where device 100 is installed, other like factors, or any combinations thereof. In various embodiments, the flexible polymer material of the second member 108 may include, but is not limited to, thermoplastic elastomer (“TPE”), thermoplastic polyurethane materials (“TPU”), other elastic polymers, fillers, binders, or any combinations thereof.

It is to be appreciated by those having ordinary skill in the art that the size, shape, and dimensions of each of the first member 106 and second member 108 are not intended to be limiting and their respective sizes, shapes, and dimensions may vary based on any of a plurality of factors in accordance with the present disclosure such as, for example, based on the diameter of the conduits being coupled together.

FIG. 2 is an exposed side view illustrating the device 100, according to some embodiments.

In various embodiments, the first member 106 may include one or more threads 118 formed on an inner surface of the channel 112. In some embodiments, the one or more threads 118 may be formed on only a portion of the inner surface of channel 112 between opening 114 and opening 116. In other embodiments, the one or more threads 118 may substantially extend an entire length of the channel 112 between opening 114 and opening 116. The one or more threads 118 may be formed in the channel 112 adjacent the opening 116, according to some embodiments. In some embodiments, the first member 106 may include one or more threads 118 at or near opening 116 and the first member 106 may include another one or more threads (not shown) at or near opening 114, the one or more threads 118 and the other threads being separated by a partition (e.g., no threads, physical partition, etc.).

In various embodiments, the first member 106 may also include a step 128 disposed in the channel 112 between opening 114 and opening 116, the step 128 circumferentially extending around the inner surface of the channel 112. The step 128 may partition the channel 112 into segment 130 and segment 132, the segment 130 extending from opening 114 to the step 128, and the segment 132 extending from opening 116 to the step 128. The step 128 acts as a physical stop when installing the conduits into the channel 112 such that neither conduit being installed therein can extend beyond the step 128 and impede on the other conduit from also being installed into the first member 106.

The position of step 128 in channel 112 along the axial direction of axis a of between opening 114 and opening 116 may vary based on one or more factors. For example, the position of step 128 along axis a may be relative based on the size and/or type of conduit being coupled to device 100. In another example, the position of step 128 may be based on a relative size of the one or more threads 118. In some embodiments, the step 128 may be disposed in a substantially central position in the channel 112 relative to opening 114 and opening 116. However, it is to be appreciated by those having ordinary skill in the art that the relative position of step 128 in the axial direction of axis a is not intended to be limiting and may include other positions along the channel 112 of first member 106. In some embodiments, the step 128 may be located in channel 112 closer to opening 114 relative opening 116. In other embodiments, the step 128 may be located in channel 112 closer to opening 116 relative opening 114.

Referring to FIG. 2, the one or more threads 118 may be formed on the inner surface of segment 132 between step 128 and opening 116, according to some embodiments. In other embodiments, the one or more threads 118 may be formed along only a portion of the length of segment 132 between step 128 and opening 116. In some embodiments, step 128 serves as a physical stop to provide a fixed distance to which the conduit being installed into the segment 132 through opening 116 can extend into the first member 106 by engaging the one or more threads 118, such that a certain number of threads of the conduit may extend beyond the first member 106 (by a fixed distance), which the second member 108 thereby covers and provides a sealed connection point to protect from water intrusion and to prevent corrosion of any susceptible metallic material with which the conduit may be made (i.e., via the exposed threads of the conduit).

Although not shown in the figures, the first member 106 may further one or more threads at one or more other locations. In a non-limiting example, the first member 106 may further include one or more threads adjacent the first end 102. In some embodiments, the first member 106 may include one or more threads located on an outer surface of the first member 106 (e.g., and external to channel 112) configured to thread into a female end of a conduit having one or more corresponding threads therein to connect the coupler to the conduit. In another embodiment, the first member 106 may include one or more threads located on an inner surface of the first member 106 and channel 112 and configured to thread onto a conduit having one or more corresponding threads to connect the coupler to the conduit.

It is to be appreciated by those having ordinary skill in the art that the first member 106 adjacent the first end 102 is not intended to be limiting and that the first member 106 and/or device 100 at first end 102 may include one or more additional structural features as can be appreciated by those having ordinary skill in the art such as to enable the appropriate conduit type to be installed onto the first member 106 and device 100 using industry standard methods and/or tools, and which may be achieved while eliminating the need to modify the device 100 or needing to install additional components (e.g., PVC patch compound) to couple the conduit to the device 100 while simultaneously achieving a connection that is free of any gaps, voids, pinholes, and/or which may cause corrosion to any of the conduits.

It is also to be appreciated that although the dimensions of channel 112 (e.g., inner diameter) and first member 106 (e.g., outer diameter) between opening 114 and opening 116 as illustrated in the figures may appear to be uniform, the drawings are exemplary and not intended to be limiting. As such, the dimension of the channel 112 between opening 114 and opening 116 may be uniform or may vary based on the diameter of the conduit being installed therein. For example, in some embodiments, the device 100 may be configured to couple two conduit having substantially similar outer diameters and the segment 130 and segment 132 may have substantially similar inner diameters. In other embodiments, the segment 130 and segment 132 may be different diameters to accommodate differently sized conduits therein. For example, the segment 130 may be a greater diameter than the segment 130. In another example, segment 130 may be a smaller diameter then segment 132. It is also to be appreciated that the thickness of the body 110 forming the channel 112 and the thickness of the body 120 forming the body 120 and channel 124 are not intended to be limiting and the thickness of the first member 106 and the second member 108 may be based on any of a plurality of factors so long as the device 100 is capable of coupling together conduits while accommodating for other design considerations such as, for example, the available space where the device 100 may be installed.

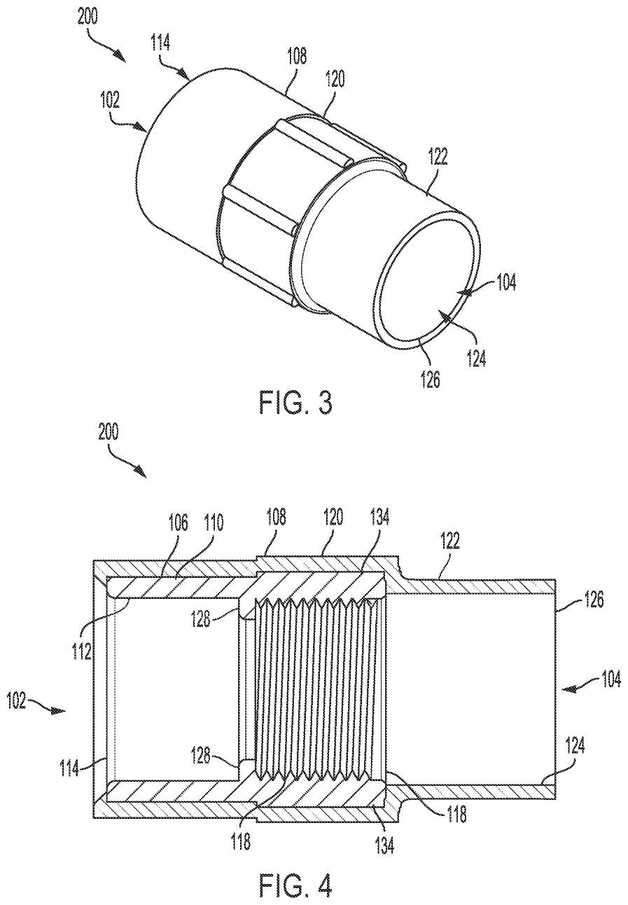

FIG. 3 is a perspective view of a device 200, according to some embodiments. FIG. 4 is an exposed side view of the device 200, according to some embodiments. Unless specifically referenced, FIGS. 3 and 4 will be collectively described.

The device 200 includes a first member 106 at a first end 102 and a second member 108 at a second end 104 similar to device 100 of FIG. 1. Referring to FIG. 3, the second member 108 of device 200 may be formed such that the second member 108 is disposed on an outer periphery of the first member 106 and conforms to an outer surface of the first member 106. In addition, the second member 108 may extend from the opening 116 to the opening 114 along the outer surface of the first member 106, according to some embodiments. In this regard, the second member 108 may be formed such that the second member 108 continuously extends from the first end 102 to the second end 104. The second member 108 may also extend from the end of first member 106 at opening 116 to the second end 104, the second member 108 defining a sealing sleeve 122 that includes a channel 124 extending from opening 116 to opening 126 located at second end 104.

Referring to FIG. 4, the first member 106 may include retention features 134 located on an outer surface of the first member 106 where the second member 108 contacts the first member 106. In some embodiments, the first member 106 may include one or more retention features 134. In other embodiments, the first member 106 may include a plurality of retention features 134. The second member 108 may conform to the profile of the first member 106 and the retention features 134, the second member 108 engaging the retention features 134 to retain a position of the second member 108 relative to the first member 106 when fully cured to prevent the first member 106 or second member 108 sliding and/or rotating relative to the other of the first member 106 and second member 108.

The retention features 134 on the first member 106 may include any of a plurality of features including, but not limited to, protrusions, ribs, embosses, detents, recesses, other features, or any combinations thereof, which the second member 108 engages when formed onto the first member 106 to retain the second member 108 in connection with the first member 106. In some embodiments, the retention features 134 may include axially extending segments (e.g., axially extending ribs) protruding from the outer surface of the first member 106. In other embodiments, the retention features 134 may include radially extending segments (e.g., radially extending ribs) protruding from the outer surface of the first member 106. In yet other embodiments, the retention features 134 may include recesses extending into the outer surface of the body 110 of first member 106. In some embodiments, the retention features 134 may include embosses protruding from the outer surface of the first member 106.

Referring to FIG. 4, the second member 108 may be formed onto a periphery of the first member 106 such that a portion of the second member 108 extends beyond the end of the first member 106 and extends towards, at least in part, opening 114 to enable the second member 108 to retain its position relative to the first member 106, according to some embodiments. In some embodiments, the first member 106 may be formed onto the first member 106 such that a portion of the second member 108 extends beyond the end of the first member 106 and extends towards, at least in part, opening 116 to enable the second member 108 to retain its position relative to the first member 106. The rigidity characteristics of the second member 108 being such that when fully cured after the manufacturing process, the second member 108 retains its position relative to the first member 106 to resist permitting the first member 106 to slide in an axial direction relative to the second member 108 and vice versa.

It is to be appreciated by those having ordinary skill in the art that the retention features 134 illustrated in FIG. 4 and the other figures is not intended to be limiting and the device 200 in various embodiments may include any of a plurality of retention features 134 to enable the second member 108 to fixedly retain its position relative to the first member 106 in accordance with the present disclosure. In some embodiments, the device 100 of FIG. 1 may include one or more of the retention features 134 in accordance with the present disclosure. It is also to be appreciated by those having ordinary skill in the art that the first member 106, in some embodiments, may not include any retention features located on the circumferential outer surface of the first member 106. In other embodiments, the first member 106 may include a step(s) (not shown) located on its outer surface such that the first member 106 includes a first outer diameter and a second outer diameter between the opening 114 and opening 116, and which the second member 108 engages to retain its position relative the first member 106.

In addition, although not shown in the figures, the device (e.g., device 200) may include an adhesive layer applied between the first member 106 and second member 108 that when fully cured fixedly attaches the first member 106 to the second member 108 to enable the first member 106 and second member 108 to fixedly retain its position relative to the other of the first member 106 and second member 108, and to prevent the first member 106 or second member 108 from sliding and/or rotating relative to the other of the first member 106 and second member 108, according to some embodiments. In some embodiments, the adhesive layer may include glue, epoxy, tape, resin, adhesive sprays, other like adhesive materials, or any combinations thereof, which when applied between contacting surfaces of the first member 106 and second member 108 may be configured to attach the first member 106 and second member 108 to the other and to prevent sliding/rotating movement relative each other. It is to be appreciated by those having ordinary skill in the art that the materials of the adhesive layer are not intended to be limiting and may include any of a plurality of materials which may be selected from a group of adhesive materials based on the materials forming the first member 106 and second member 108 to enable the first member 106 to fixedly attach to the second member 108.

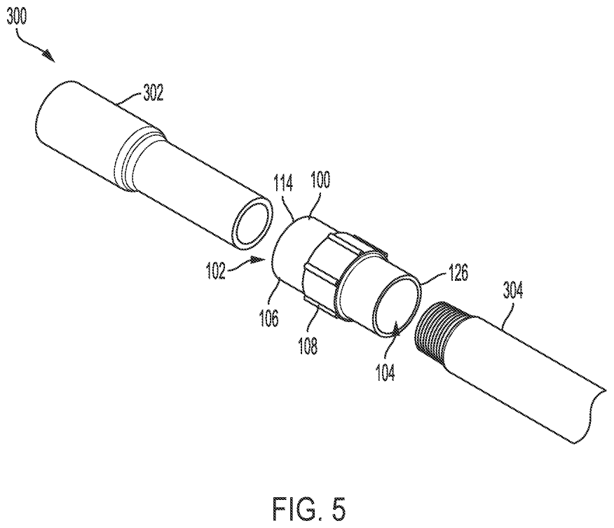

FIG. 5 is a perspective view illustrating a system 300 including the device 100 of FIG. 1, according to some embodiments.

The device 100 may be configured to receive conduit 302 at the first end 102 and into opening 114, and the device 100 may also be configured to receive conduit 304 at the second end 104 into opening 126, the conduit 302 and conduit 304 being installed therein until they each engage the first member 106 such that the device 100 couples to conduit 302 and conduit 304, according to various embodiments. In some embodiments, the device 100 may be configured to couple together different conduit types, thereby placing a conduit system having one or more segments of conduit 302 in fluid communication with another conduit system having one or more of conduit 304. In some embodiments, the device 100 may be configured to receive conduit 302 into the first end 102 and receive conduit 304 into the second end 104 such that the device 100 couples to the conduit 302 and conduit 304. In this regard, the device 100 is configured to serve as a transition from one conduit to another conduit and/or from one conduit type to another conduit type while decreasing the amount of labor and additional materials needed to couple the conduits together, thereby improving the overall reliability and performance of the connection between the conduits by eliminating the need to modify the coupling device.

The conduit 302 and conduit 304 may be conduits of different types, according to various embodiments. In this regard, conduit 302 and conduit 304 may be formed of one or more different materials. In some embodiments, conduit 302 may be a non-metallic PVC conduit configured to be inserted into opening 114, the conduit 302 engaging the first member 106 at channel 112 and engaging the first member 106 to couple to the device 100. For example, the conduit 302 may have an outer diameter configured to couple to the first member 106 by interference fit. In some embodiments, a patch compound may also be applied to the conduit 302 and/or to the inner surface of channel 112 at the first end 102 such that the conduit 302 forms a sealed connection with the device 100 that is free of gaps or pinholes to resist or prevent water intrusion. In addition, in some embodiments, the conduit 304 may be a PVC coated 306 metallic conduit configured to be inserted into opening 126 at the second end 104, the conduit 304 being installed into device 100 such that the conduit 304 extends through the channel 124, into opening 116, and engages the one or more threads 118 of the first member 106.

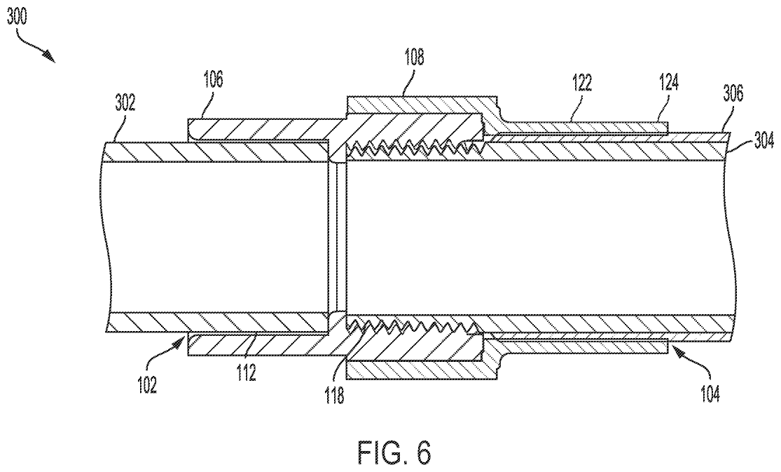

FIG. 6 is an exposed side view of the system 300 including the device 100 of FIG. 1, according to some embodiments.

As shown in FIG. 6, the end of conduit 304 may be a male end having one or more threads formed thereon which is configured to engage the one or more threads 118 of the first member 106. The conduit 304 being configured to be threaded into the first member 106 to a specified installation position. In some embodiments, the conduit 304 may be configured to be installed into the first member 106 until the conduit 304 engages the step 128.

In addition, although not shown in FIG. 6, when the conduit 304 is fully installed into the device 100 and the one or more threads of the conduit 304 fully engages the one or more threads 118 of the first member 106, one or more threads on the conduit 304 may extend beyond the edge defined by opening 116 and the body 110 of the first member 106. As such, the sealing sleeve 122 of the second member 108 also extends beyond the body 110 of the first member 106, the sealing sleeve 122 enveloping the circumferential outer surface of the conduit 304 and providing a sealed connection point between the first member 106 and the conduit 304. In some embodiments, the second member 108 may extend beyond the first member 106 by a length capable of covering any exposed threads of the conduit 304 from the connection point. In some embodiments, the conduit 304 may be a PVC coated 306 metallic conduit, which when installed into the device 100 may include one or more threads that extend beyond the first member 106 and that are formed in the PVC coating 306 and/or the metallic conduit, thereby exposing one or more metallic threads that can be susceptible to corrosion, and which may cause pinholes or gaps therebetween. By covering the exposed threads of conduit 304 with the sealing sleeve 122, the second member 108 provides a sealed connection point and protects the exposed threads of the metallic material of conduit 304 from corrosion.

In some embodiments, an adhesive configured to be used to provide sealed connections at PVC conduits and fittings and the like may be applied to conduit 302 prior to being inserted into the first end 102 of device 100 (e.g., opening 114 of the first member 106) to help ensure that the connection point between the conduit 302 and the first member 106 is fully sealed when the adhesive sufficiently cures and so that there are no air gaps or pinholes at the connection point. In other embodiments, the adhesive may also be applied to the end of conduit 304 that is configured to be inserted into the second end 104 of device 100 to help ensure that the connection between the conduit 304 and the first member 106 and/or the seal provided by the second member 108 is free of gaps or pinholes. In some embodiments, the adhesive may include, but is not limited to, glues, pipe dopes, PVC tapes, latex tapes, PVC patch compounds, joint compounds, other like adhesives, or any combinations thereof.

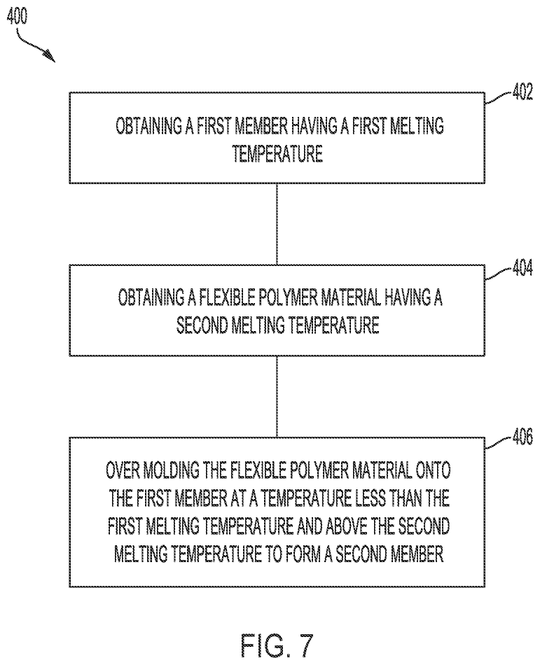

FIG. 7 is a flow diagram illustrating a method 400, according to some embodiments.

At 402, the method 400 includes obtaining a first member 106 having a first melting temperature. In some embodiments, the first member 106 includes a body 110 defining a channel 112 having a first opening 114 and a second opening 116, and one or more threads 118 located on an inner surface of the channel 112 at the second opening 116. The first member 106 may be formed of non-metallic PVC conduit, in some embodiments.

At 404, the method 400 includes obtaining a flexible polymer material having a second melting temperature. The second melting temperature enables the flexible polymer material to be molded or over molded onto the first member 106 to form a second member 108 without causing material degradation of the first member 106 due to the temperature of the flexible polymer material when molded onto the first member 106 being greater than the first melting temperature. In some embodiments, the first melting temperature may be substantially similar to the second melting temperature. In other embodiments, the first melting temperature may be greater than or equal to the second melting temperature.

At 406, the method 400 includes over molding the flexible polymer material onto the first member 106 at a temperature less than the first melting temperature and above the second melting temperature to form a second member 108. In some embodiments, a portion of the second member 108 axially extending from the first member 106 further defines the channel 112 (e.g., channel 124) such that a first end 102 of the coupling device (e.g., device 100) is in fluid communication with a second end 104 of the coupling device.

The second member 108, when fully cured, may include certain rigidity characteristics to retain its position relative to the first member 106 and to resist conduits have too large a diameter from being inserted into the second member 108. In some embodiments, the rigidity characteristics of the second member 108 may cause the second member 108 to permanently deform or shear (e.g., tear) when a conduit having too large an outer diameter is installed therein. In addition, in other embodiments, the second member 108, when fully cured, may include certain elastic characteristics to enable the second member 108 to receive therein conduits having an outer diameter within a certain threshold based on the diameter of the second member 108 while also being able to provide a sealed connection point when the conduit 304 is fully installed into the first member 106.

In some embodiments, the method 400 may further include applying an adhesive onto an outer surface of the first member 106 to enable the second member 108 to attach to the first member 106. In some embodiments, the adhesive may be selected from a group of materials based on a material or materials forming the first member 106 and a material or materials forming the second member to enable the adhesive to attach the first member 106 to the second member 108.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

### ASPECTS

Various Aspects are described below. It is to be understood that any one or more of the features recited in the following Aspect(s) can be combined with any one or more other Aspect(s).
Aspect 1. A device for coupling a first conduit and a second conduit comprising: a first member comprising: a body defining a channel having a first opening and a second opening, and one or more threads located on an inner surface of the channel at the second opening, wherein the first member is configured to receive the first conduit at the first opening and receive the second conduit at the second opening, and the one or more threads engages one or more threads of the second conduit; and a second member circumferentially disposed around a periphery of the first member at the second opening and axially extending from the first member, wherein the second member comprises an inner diameter configured based on an outer diameter of the second conduit to enable a portion of the second member extending from the first member to form a seal around the second conduit when the second conduit fully engages the first member.
Aspect 2. The device according to aspect 1, wherein the first member comprises a non-metallic Polyvinyl Chloride (PVC) material.
Aspect 3. The device according to any of the preceding aspects, wherein the second member comprises a flexible polymer.
Aspect 4. The device according to aspect 3, wherein the second member comprises a rigidity provided by the flexible polymer to enable forming the seal between the second conduit and the first member, wherein the second member further comprises an elasticity provided by the flexible polymer to enable the second member to conform to an outer diameter of the second conduit.
Aspect 5. The device according to any of the preceding aspects, wherein the device is formed by over molding the second member onto the periphery of the first member, wherein a melting temperature of the first member is substantially similar to a melting temperature of the second member.
Aspect 6. The device according to any of the preceding aspects, further comprising: an adhesive, and wherein the adhesive attaches the first member to the second member, wherein the adhesive is made of a material selected based on a material of the first member and the second member to enable the adhesive to attach the first member to the second member.
Aspect 7. The device according to any of the preceding aspects, wherein the first conduit comprises a non-metallic PVC conduit, wherein the second conduit comprises a PVC coated metallic conduit.
Aspect 8. The device according to any of the preceding aspects, wherein the portion of the second member extending from the first member further defines the channel, wherein the channel extends through the first member and the second member such that a first end of the device is in fluid communication with a second end of the device.
Aspect 9. The device according to any of the preceding aspects, wherein the first member is further configured to engage the first conduit such that a seal is formed when the first conduit is fully inserted into the channel at the first opening.
Aspect 10. The device according to aspect 9, further comprising: an adhesive, wherein the adhesive is configured to be applied to respective surfaces of the first conduit and the first member to enable the seal to be formed between the first conduit and the first member.
Aspect 11. A system for connecting a first conduit to a second conduit comprising: a coupling device for coupling the first conduit and the second conduit comprising: a first member comprising: a body defining a channel having a first opening and a second opening, and one or more threads located on an inner surface of the channel at the second opening, wherein the first member is configured to receive the first conduit at the first opening and receive the second conduit at the second opening, and the one or more threads engages one or more threads of the second conduit; and a second member circumferentially disposed around a periphery of the first member at the second opening and axially extending from the first member, wherein the second member comprises an inner diameter configured based on an outer diameter of the second conduit to enable a portion of the second member extending from the first member to form a seal around the second conduit when the second conduit fully engages the first member; wherein the channel extends through the first member and the second member such that a first end of the coupling device is in fluid communication with a second end of the coupling device; wherein the coupling device is formed by over molding the second member onto the periphery of the first member.
Aspect 12. The system according to aspect 11, wherein the first member comprises a non-metallic Polyvinyl Chloride (PVC) material, wherein the second member comprises a flexible polymer.
Aspect 13. The system according to aspects 11 or 12, wherein the first conduit comprises a non-metallic PVC conduit, wherein the second conduit comprises a PVC coated metallic conduit.
Aspect 14. The system according to aspect 12, wherein the second member comprises a rigidity provided by the flexible polymer to enable forming the seal between the second conduit and the first member, wherein the second member further comprises an elasticity provided by the flexible polymer to enable the second member to conform to an outer diameter of the second conduit.
Aspect 15. The system according to aspects 11, 12, 13, or 14, wherein a melting temperature of the first member is substantially similar to a melting temperature of the second member.
Aspect 16. The system according to aspects 11, 12, 13, 14, or 15, further comprising: an adhesive, and wherein the adhesive attaches the first member to the second member, wherein the adhesive is made of a material selected based on a material of the first member and the second member to enable the adhesive to attach the first member to the second member.
Aspect 17. The system according to aspects 11, 12, 13, 14, 15, or 16, wherein the first member is further configured to engage the first conduit such that a sealed connection is formed when the first conduit is fully inserted into the channel at the first end.
Aspect 18. The system according to aspects 11, 12, 13, 14, 15, 16, or 17, further comprising: an adhesive, wherein the adhesive is configured to be applied to surfaces of the first conduit and the first member to enable the sealed connection to be formed between the first conduit and the first member.
Aspect 19. A method of manufacturing a coupling device comprising: obtaining a first member having a first melting temperature, wherein the first member comprises a body defining a channel having a first opening and a second opening, and one or more threads located on an inner surface of the channel at the second opening; obtaining a flexible polymer material having a second melting temperature; and over molding the flexible polymer material onto the first member at a temperature less than the first melting temperature and above the second melting temperature to form a second member; wherein a portion of the second member axially extending from the first member further defines the channel such that a first end of the coupling device is in fluid communication with a second end of the coupling device.
Aspect 20. The method according to aspect 19, further comprising: applying an adhesive onto an outer surface of the first member to enable the second member to attach to the first member, wherein the adhesive is selected from a group of materials based on a material of the first member and the second member to enable the adhesive to attach the first member to the second member.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A device for coupling a first conduit and a second conduit comprising:
a first member comprising:
a body defining a channel having a first opening and a second opening, and
one or more threads located on an inner surface of the channel at the second opening,
wherein the first member is configured to receive the first conduit at the first opening and receive the second conduit at the second opening, and
the one or more threads engages one or more threads of the second conduit; and
a second member circumferentially disposed around a periphery of the first member at the second opening and axially extending from the first member,
wherein the second member comprises an inner diameter configured based on an outer diameter of the second conduit to enable a portion of the second member extending from the first member to form a seal around the second conduit when the second conduit fully engages the first member.

2. The device according to claim 1, wherein the first member comprises a non-metallic Polyvinyl Chloride (PVC) material.

3. The device according to claim 2, wherein the second member comprises a flexible polymer.

4. The device according to claim 3, wherein the second member comprises a rigidity provided by the flexible polymer to enable forming the seal between the second conduit and the first member,
wherein the second member further comprises an elasticity provided by the flexible polymer to enable the second member to conform to an outer diameter of the second conduit.

5. The device according to claim 3, wherein the device is formed by over molding the second member onto the periphery of the first member,
wherein a melting temperature of the first member is substantially similar to a melting temperature of the second member.

6. The device according to claim 1, further comprising:
an adhesive, and
wherein the adhesive attaches the first member to the second member,
wherein the adhesive is made of a material selected based on a material of the first member and the second member to enable the adhesive to attach the first member to the second member.

7. The device according to claim 1, wherein the first conduit comprises a non-metallic PVC conduit,
wherein the second conduit comprises a PVC coated metallic conduit.

8. The device according to claim 1, wherein the portion of the second member extending from the first member further defines the channel,
wherein the channel extends through the first member and the second member such that a first end of the device is in fluid communication with a second end of the device.

9. The device according to claim 1, wherein the first member is further configured to engage the first conduit such that a seal is formed when the first conduit is fully inserted into the channel at the first opening.

10. The device according to claim 9, further comprising:
an adhesive,
wherein the adhesive is configured to be applied to respective surfaces of the first conduit and the first member to enable the seal to be formed between the first conduit and the first member.

11. A system for connecting a first conduit to a second conduit comprising:
a coupling device for coupling the first conduit and the second conduit comprising:
a first member comprising:
a body defining a channel having a first opening and a second opening, and
one or more threads located on an inner surface of the channel at the second opening,
wherein the first member is configured to receive the first conduit at the first opening and receive the second conduit at the second opening, and the one or more threads engages one or more threads of the second conduit; and
a second member circumferentially disposed around a periphery of the first member at the second opening and axially extending from the first member,
wherein the second member comprises an inner diameter configured based on an outer diameter of the second conduit to enable a portion of the second member extending from the first member to form a seal around the second conduit when the second conduit fully engages the first member;
wherein the channel extends through the first member and the second member such that a first end of the coupling device is in fluid communication with a second end of the coupling device;
wherein the coupling device is formed by over molding the second member onto the periphery of the first member.

12. The system according to claim 11, wherein the first member comprises a non-metallic Polyvinyl Chloride (PVC) material,
wherein the second member comprises a flexible polymer.

13. The system according to claim 12, wherein the first conduit comprises a non-metallic PVC conduit,
wherein the second conduit comprises a PVC coated metallic conduit.

14. The system according to claim 12, wherein the second member comprises a rigidity provided by the flexible polymer to enable forming the seal between the second conduit and the first member,
wherein the second member further comprises an elasticity provided by the flexible polymer to enable the second member to conform to an outer diameter of the second conduit.

15. The system according to claim 11, wherein a melting temperature of the first member is substantially similar to a melting temperature of the second member.

16. The system according to claim 11, further comprising:
an adhesive, and
wherein the adhesive attaches the first member to the second member,
wherein the adhesive is made of a material selected based on a material of the first member and the second member to enable the adhesive to attach the first member to the second member.

17. The system according to claim 11, wherein the first member is further configured to engage the first conduit such that a sealed connection is formed when the first conduit is fully inserted into the channel at the first end.

18. The system according to claim 17, further comprising:
an adhesive,
wherein the adhesive is configured to be applied to surfaces of the first conduit and the first member to enable the sealed connection to be formed between the first conduit and the first member.

19. A method of manufacturing a coupling device comprising:
obtaining a first member having a first melting temperature, wherein the first member comprises a body defining a channel having a first opening and a second opening, and one or more threads located on an inner surface of the channel at the second opening;
obtaining a flexible polymer material having a second melting temperature; and
over molding the flexible polymer material onto the first member at a temperature less than the first melting temperature and above the second melting temperature to form a second member;
wherein a portion of the second member axially extending from the first member further defines the channel such that a first end of the coupling device is in fluid communication with a second end of the coupling device.

20. The method according to claim 19, further comprising:
applying an adhesive onto an outer surface of the first member to enable the second member to attach to the first member,
wherein the adhesive is selected from a group of materials based on a material of the first member and the second member to enable the adhesive to attach the first member to the second member.
